(19) United States
(12) Patent Application Publication
(10) Pub. No.: US 2008/0108264 A1
(43) Pub. Date: May 8, 2008

(54) Fireproof pavement

(75) Inventors: Tsao Chang, Lu-Chu Hsiang (TW); Shyh-Shiaw Lee, Lu-Chu Hsiang (TW); Jiune-Jye Hwang, Lu-Chu Hsiang (TW); Shian-Tsung Chou, Lu-Chu Hsiang (TW)

Correspondence Address: TROXELL LAW OFFICE PLLC;SUITE 1404, 5205 LEESBURG PIKE, FALLS CHURCH, VA, 22041, US

(73) Assignee: International Carbide Technology Co., Ltd.

(21) Appl. No.: 11/592,232

(22) Filed: Nov. 3, 2006

(51) Int. Cl. B32B 5/02

(52) U.S. Cl. 442/141; 442/136

(57) ABSTRACT

A fireproof pavement includes a fabric top layer, a fireproof adhesion layer and a bottom layer; the fireproof adhesion layer being admixed with a flame retardant composition comprising at least two components selected from the group consisting of an expandable graphite, a char former, a char catalyst and a filler, and being sandwiched by and securing both top and bottom layers; the pavement (e.g., carpet) being paved on a surface (e.g. floor) and the fireproof adhesion layer providing fire retardant effects when the pavement is subject to flame.

### BACKGROUND OF THE INVENTION

(a) Field of the Invention

The present invention is related to a fireproof pavement, and more particular to one that when paved creates heat insulation and fire retardant effects provided by a fireproof adhesion layer.

(b) Description of the Prior Art

Upgraded demands on living quality at home motivates many home units to select carpet to pave on the floor for the house to deliver an elegant style in general. The flooring material of carpet is available in two basic forms. One type of carpet has a piece of non-woven fabric directly pressed into form. The advantages of this type of carpet includes consistent material and allowing proper deformation by compromising the fluctuation of the site of pavement; and its drawback is that it is not ideal for being cut into smaller pieces due to poor property of falling into shape. Another type of carpet and a more popular one allows to be cut into smaller pieces for combination as desired or according to the area of the floor. For this combination type of carpet, each piece must maintain a specific shape to facilitate combination. Therefore, a non-woven layer 11 is fixed to the plastic molded bottom layer 12 as illustrated in FIG. 1 of the accompanying drawings so to form a carpet 1 that is capable of maintaining a preset form.

However, whether the carpet of the prior art is made an integrated piece of non-woven fabric by press or having the non-woven fabric layer fixed to a plastic molded bottom layer, their compositions e.g., the simple non-woven fabric with or without being mixed with the plastic material is related to inflammable material. Accordingly, when the carpet subject to heat or flame, the carpet will be burnt out without providing any heat insulation or flame retardant function to the floor paved with the carpet.

### SUMMARY OF THE INVENTION

The primary purpose of the present invention is to provide a fireproof pavement which when laid on a surface, a fireproof adhesion layer disposed in the bottom of the pavement would provide heat insulation and fire retardant effects to protect the area where covered by the pavement.

To achieve the purpose, the present invention includes case (1) a fabric top layer and a fireproof adhesion layer; or case (2) a fabric top layer, a fireproof adhesion layer and a bottom layer. In case (1) or (2), the fireproof adhesion layer contains an adhesive base material and a flame retardant composition comprising at least two components selected from the group consisting of an expandable graphite, a char former, a char catalyst and a filler. In case (2), the fireproof adhesion layer is sandwiched by and secures both top and bottom layers. When the pavement (e.g., carpet) is paved on a surface (e.g. floor), the bottom layer of the pavement prevents seepage by oil or water to contaminate the surface; and the fireproof adhesion layer provides heat insulation and fire retardant effects when the pavement is subject to heat or flame.

### BRIEF DESCRIPTION OF THE DRAWINGS

FIG. 1 is a schematic view showing a construction of a carpet of the prior art.

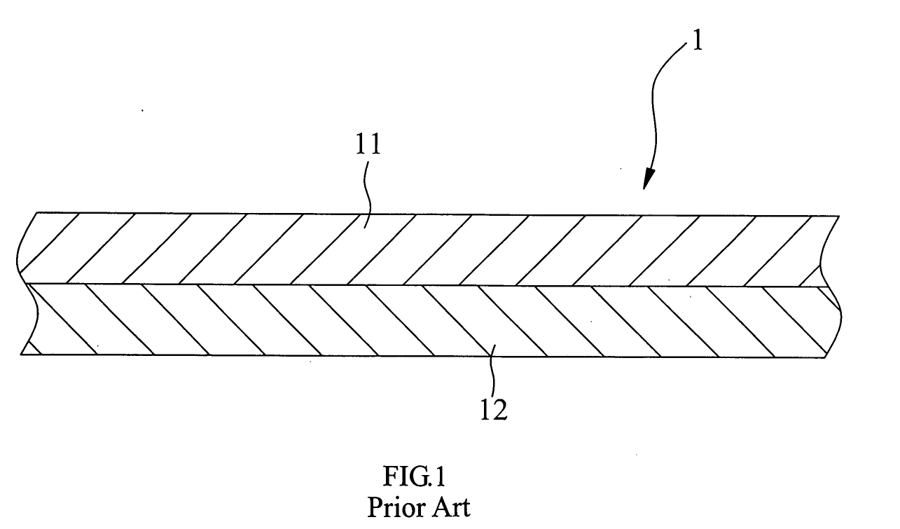

FIG. 2 is a schematic view showing a construction of a first preferred embodiment of the present invention.

FIG. 3 is a schematic view showing a construction of a second preferred embodiment of the present invention.

FIG. 4 is a schematic view showing an operation status of the present invention.

FIG. 5 is a schematic view showing a construction of a third preferred embodiment of the present invention.

### DETAILED DESCRIPTION OF THE PREFERRED EMBODIMENTS

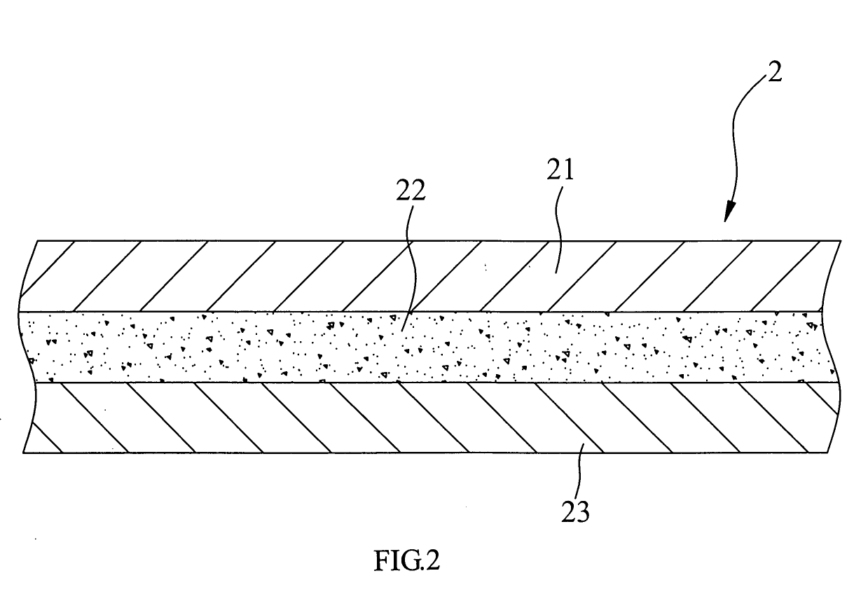

Referring to FIG. 2 for the first preferred embodiment of the present invention, the fireproof pavement 2 includes a fabric top layer 21 made of non-woven fabric, and a fireproof adhesion layer 22 coated to the underside of the top layer 21. The fireproof adhesion layer 22 contains an adhesive base material and a flame retardant composition comprising at least two components selected from the group consisting of an expandable graphite, a char former, a char catalyst and a filler to achieve the fire retardant and heat insulation results.

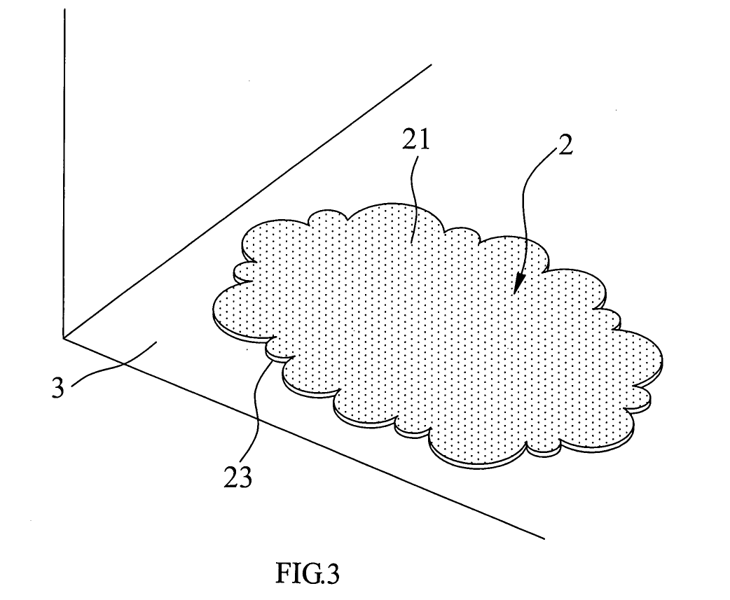

Referring to FIG. 3 for the second preferred embodiment of the present invention, a fireproof pavement 2 includes a top layer 21 made of fabric material including non-woven fabric; a fireproof adhesion layer 22 coated to the underside of the top layer 21, and the fireproof adhesion layer 22 contains an adhesive base material and a flame retardant composition comprising at least two components selected from the group consisting of an expandable graphite, a char former, a char catalyst and a filler; and a bottom layer 23 disposed to the underside of the fireproof adhesion layer 22 to prevent seepage of oil or water and slippage.

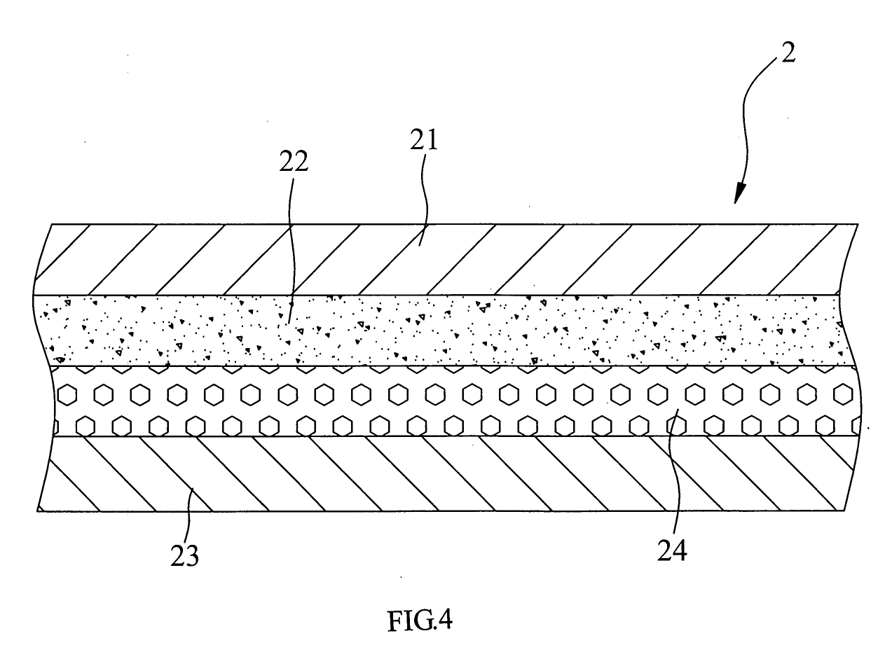

Accordingly, the fireproof adhesion layer 22 secures both of the top layer 21 and the bottom layer 23. When the fireproof pavement 2 (e.g., in the form of a carpet) is laid on a surface 3 (e.g., floor) as illustrated in FIG. 4 with the top layer 21 facing upward and the bottom layer 23 to contact the surface 3. Once the fireproof pavement 2 is subject to heat or flame, the top layer 21 may be burnt out, but the char former in the fireproof adhesion layer will be dehydrated to form a char layer at where the surface of the adhesive base material is subject to heat while firmly holding the expandable graphite growing into vermicular intumescence due to the heat or flame to the char layer. The hard and firm char layer and the vermicular intumescent graphite secured by the char provide double effects of heat insulation and fire retardant to be more effectively in stopping the fire and preventing the flame from extending to the surface. Furthermore, when any oil or water drops onto the fireproof pavement 2, the bottom layer 23 will prevent the oil or water from seeping to the surface 3 so to maintain the surface 3 in clean condition.

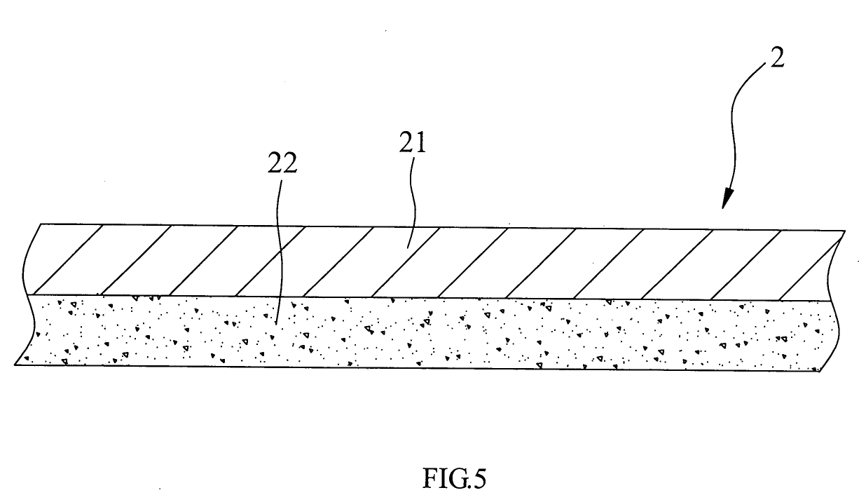

FIG. 5 shows the third preferred embodiment of the present invention, the fireproof pavement 2 includes the top layer 21 made of fabric material including non-woven fabric; a fireproof adhesion layer 22 coated to the underside of the top layer 21 and contains an adhesive base material and a flame retardant composition comprising at least two components selected from the group consisting of an expandable graphite, a char_former, a char catalyst and a filler; an adhesion layer 24 comprised of adhesive generally available in the market coated to the underside of the fireproof adhesion layer 22; and the bottom layer 23 disposed to the underside of the adhesion layer 24.

Similar to the second prefer-red embodiment of the present invention, the fireproof adhesion layer 22 provides heat insulation and fire retardant effects while the adhesion layer 24 helps further secure the fireproof adhesion layer 22 and the bottom layer 23.

For these preferred embodiments of the present invention, the adhesive base material of the fireproof adhesion layer may be related to the adhesive based on rubber, acrylic, polyurethane or silicone rubber; the flame retardant composition in the fireproof adhesion layer may be about 20-80% by weight; the flame retardant composition comprising at least two components selected from the group consisting of an expandable graphite, a char former, a char catalyst and a filler. The particle size of the expandable graphite powder is 20-200 mesh. The char former may be related to polyatomic alcohol (e.g., that selected from pentaerythritol, di-pentaerythritol, polypentaerythritol, glycerin, trimethamine, trimethylpropane, glycol, propylene glycol, cyclohexanediol), or to polysaccharide (e.g., that selected from sorbitol, glucose, galactose, fructose, arabinose, sucrose, starch, dextrin, pectin, or fruit acids). The char catalyst may be related to chemical containing phosphorus (e.g., that selected from red phosphorus, melamine pyrophosphate, guanidine phosphate urea, orthophosphoric acid, tripolyphosphate, metaphosphate, polyphosphate, phosphorous acid, hexametaphosphate, ammonium polyphosphate, ammonium dihydrogen phosphate, ammonium hydrogen phosphate, ammonium metaphosphate, ammonium phosphorous acid, ammonium pyrophosphate, ammonium hexametaphosphate, phosphorous chloride, phosphorous oxychloride, or phosphorous pentoxide). The filler may be selected from the group consisting of talc, mica, kaolin clay, chalk, wollastonite, melamine, fume silica, quartz, aluminum hydroxide, magnesium hydroxide, calcium hydroxide, calcium carbonate, barium sulfate, aluminosilicate, zinc borate, ammonium molybdate, titanium dioxide, zinc oxide, aluminum oxide, antimony oxide, silica, magnesium oxide, glass fiber and graphite or mixtures thereof.

The example formulas of the flame retardant composition are shown below:

Formula (I), the flame retardant composition consist of:

| | |
|---|---|
| char catalyst (tripolyphosphate) | 10–80% by weight; |
| filler (aluminum hydroxide) | 20–90% by weight. |

Formula (II), the flame retardant composition consist of:

| | |
|---|---|
| expandable graphite | 5–10% by weight; |
| char catalyst (melamine pyrophosphate) | 50–70% by weight; |
| char former (pentaerythritol) | 15–30% by weight; |
| filler(titanium dioxide) | 10–20% by weight. |

Formula (III), the flame retardant composition consist of:

| | |
|---|---|
| expandable graphite | 30–50% by weight; |
| char catalyst (melamine pyrophosphate) | 50–70% by weight. |

Formula (IV), the flame retardant composition consist of:

| | |
|---|---|
| expandable graphite | 30–40% by weight; |
| char catalyst(polyphosphate) | 40–60% by weight; |
| char former(di-pentaerythritol) | 10–20% by weight. |

Formula (V), the flame retardant composition consist of:

| | |
|---|---|
| char catalyst (ammonium polyphosphate) | 50–85% by weight; |
| char former(sorbitol) | 5–30% by weight; |
| filler(melamine) | 10–30% by weight. |

Table (1) is the examples of the fireproof adhesion layer:

TABLE (1)

| | Example | | | | |
|---|---|---|---|---|---|
| | 1 | 2 | 3 | 4 | 5 |
| adhesive base material | | | | | |
| silicone rubber | 50–70% | 50–70% | | | |
| acrylic | | | 50–80% | | |
| styrene butadiene rubber | | | | 20–50% | |
| polyurethane | | | | | 60–80% |
| Formula (I) | 30–50% | | | | |
| Formula (II) | | 30–50% | | | |
| Formula (III) | | | 20–50% | | |
| Formula (IV) | | | | 50–80% | |
| Formula (V) | | | | | 20–40% |

All are related to weight percents.

The present invention provides a preferred structure of a fireproof pavement, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I Claim,

1. A fireproof pavement, comprising: a top layer made of fabric material; and a fireproof adhesion layer which containing an adhesive base material admixed with a flame retardant composition disposed to the underside of the top layer; the flame retardant composition comprising at least two components selected from the group consisting of an expandable graphite, a char former, a char catalyst and a filler.

2. The fireproof pavement as claimed in claim 1, wherein the top layer is related to a non-woven fabric material.

3. The fireproof pavement as claimed in claim 1, wherein the flame retardant composition consisting of the char catalyst about 10 to 85% by weight.

4. The fireproof pavement as claimed in claim 1, wherein the flame retardant composition consisting of the expandable graphite about 5 to 50% by weight.

5. The fireproof pavement as claimed in claim 1, wherein the flame retardant composition consisting of the char former about 5 to 30% by weight.

6. The fireproof pavement as claimed in claim 1, wherein the flame retardant composition consisting of the filler about 10 to 90% by weight.

7. The fireproof pavement as claimed in Claim -1, wherein the particle size of the expandable graphite powder is about 20 to 200 mesh.

8. The fireproof pavement as claimed in claim 1, wherein the flame retardant composition in the fireproof adhesion layer is about 20 to 80% by weight.

9. The fireproof pavement as claimed in claim 1, wherein the adhesive base material is selected from an adhesive based on rubber, acrylic, polyurethane, silicone rubber or mixtures thereof.

10. The fireproof pavement as claimed in claim 1, wherein the char former is selected from polyatomic alcohol, polysaccharide or mixtures thereof.

11. The fireproof pavement as claimed in claim 1, wherein the char catalyst is a phosphorus containing chemical.

12. The fireproof pavement as claimed in claim 1, wherein the filler is selected from talc, mica, kaolin clay, chalk, wollastonite, melamine, fume silica, quartz, aluminum hydroxide, magnesium hydroxide, calcium hydroxide, calcium carbonate, barium sulfate, aluminosilicate, zinc borate, ammonium molybdate, titanium dioxide, zinc oxide, aluminum oxide, antimony oxide, silica, magnesium oxide, glass fiber, graphite or mixtures thereof.

13. A fireproof pavement, comprising: a top layer made of fabric material; a fireproof adhesion layer which containing an adhesive base material admixed with a flame retardant composition disposed to the underside of the top layer; the flame retardant composition comprising at least two components selected from the group consisting of an expandable graphite, a char former, a char catalyst and a filler; and a bottom layer disposed to the underside of the fireproof adhesion layer.

14. The fireproof pavement as claimed in claim 13, wherein the top layer is related to a non-woven fabric material.

15. The fireproof pavement as claimed in claim 13, wherein the flame retardant composition consisting of the char catalyst about 10 to 85% by weight.

16. The fireproof pavement as claimed in claim 13, wherein the flame retardant composition consisting of the expandable graphite about 5 to 50% by weight.

17. The fireproof pavement as claimed in claim 13, wherein the flame retardant composition consisting of the char former about 5 to 30% by weight.

18. The fireproof pavement as claimed in claim 13, wherein the flame retardant composition consisting of the filler about 10 to 90% by weight.

19. The fireproof pavement as claimed in claim 13, wherein the particle size of the expandable graphite powder is about 20 to 200 mesh.

20. The fireproof pavement as claimed in claim 13, wherein the flame retardant composition in the fireproof adhesion layer is about 20 to 80% by weight.

21. The fireproof pavement as claimed in claim 13, wherein the adhesive base material is selected from an adhesive based on rubber, acrylic, polyurethane, silicone rubber or mixtures thereof.

22. The fireproof pavement as claimed in claim 13, wherein the char former is selected from polyatomic alcohol, polysaccharide or mixtures thereof.

23. The fireproof pavement as claimed in claim 13, wherein the char catalyst is a phosphorus containing chemical.

24. The fireproof pavement as claimed in claim 13, wherein the filler is selected from talc, mica, kaolin clay, chalk, wollastonite, melamine, fume silica, quartz, aluminum hydroxide, magnesium hydroxide, calcium hydroxide, calcium carbonate, barium sulfate, aluminosilicate, zinc borate, ammonium molybdate, titanium dioxide, zinc oxide, aluminum oxide, antimony oxide, silica, magnesium oxide, glass fiber, graphite or mixtures thereof.

25. The fireproof pavement as claimed in claim 13 further comprising an adhesion layer disposed between the fireproof adhesion layer and the bottom layer.
